(19) United States
(12) Patent Application Publication
(10) Pub. No.: US 2003/0143447 A1
(43) Pub. Date: Jul. 31, 2003

(54) Fuel cells power generation system

(75) Inventors: Naomichi Akimoto, Nagoya-shi (JP); Takeshi Masui, Okazaki-shi (JP); Koichiro Hara, Toyota-shi (JP); Nobuki Hattori, Nagoya-shi (JP); Osamu Nakanishi, Obu-shi (JP); Shiroh Yamasaki, Toyoake-shi (JP); Yasuhito Noguchi, Kariya-shi (JP)

Correspondence Address: George E. Badenoch, Esq., Kenyon & Kenyon, One Broadway, New York, NY, 10004, US

(73) Assignee: TOYOTA JIDOSHA KABUSHIKI KAISHA, Toyota-shi (JP)

(21) Appl. No.: 10/355,128

(22) Filed: Jan. 31, 2003

(30) Foreign Application Priority Data
Jan. 31, 2002 (JP) 2002-023660

(51) Int. Cl. H01M 8/04

(52) U.S. Cl. 429/23; 429/24; 429/26

(57) ABSTRACT

The power generation mode of fuel cells included in a fuel cells power generation system, the quantity of power generation by the fuel cells, the working power used for a load, the amount of hot water kept in a hot water tank, the time, the occurrence of an abnormality in the system, and a request for regular inspection are displayed on a display unit of an operation display panel as numerical values and stepwise-variable graphical expression representing variations in quantity. The user is accordingly informed of the current driving conditions of the system and the working power used for the load, and sets the power generation mode of the fuel cells based on these pieces of information. This enables the user to adequately and readily control the operations of the system.

### BACKGROUND OF THE INVENTION

1. Field of the Invention

The present invention relates to a fuel cells power generation system. More specifically the invention pertains to a fuel cells power generation system including fuel cells, which receive a supply of a fuel and generate electric power, and also to an operation display device used for the system.

2. Description of the Prior Art

One proposed fuel cells power generation system (for example, PATENT LAYING-OPEN GAZETTE No. 2001-210343) is a fuel cells cogeneration system for domestic use, which includes proton-exchange membrane fuel cells and a hot water tank storing hot water heated with heat produced in the process of power generation by the fuel cells. Electric power generated by the fuel cells is supplied to part of electrical home appliances, while hot water is supplied from the hot water tank. This system is designed to be located outdoors.

In such a fuel cells power generation system, the fuel cells and the hot water tank are located outdoors, but an operation panel manipulated to control operations of the system is generally located indoors for the user's convenience. The user has difficulties in setting the driving conditions of the system, in the case where the electric power used indoors is unknown or the operating state of the fuel cells is unknown.

### SUMMARY OF THE INVENTION

The object of the present invention is thus to provide a fuel cells power generation system and an operation display device used for the system that enable easy setting of driving conditions of the system. The object of the invention is also to provide a fuel cells power generation system and an operation display device used for the system that display information regarding the system, for example, the driving conditions of the system and the working power. The object of the invention is further to provide a fuel cells power generation system that displays the occurrence of an abnormality in the system and a request for inspection.

In order to achieve at least a part of the aforementioned objects, the fuel cells power generation system and the operation display device used for the system of the present invention are structured as follows.

A first fuel cells power generation system of the present invention is a fuel cells power generation system, including:

fuel cells that receive a supply of a fuel and generate electric power;

a hot water tank that stores hot water heated with at least heat from the fuel cells; and

an operation display module having an operation unit that is manipulated to control operations of the fuel cells and a display unit that displays an output electric power from the fuel cells and a hot water storage state in the hot water tank.

In the first fuel cells power generation system of the invention, the output electric power from the fuel cells and the hot water storage state in the hot water tank are displayed on the display unit of the operation display module. The user is accordingly informed of the output electric power from the fuel cells and the hot water storage state in the hot water tank. The user can thus manipulate the operation unit to control the operations of the fuel cells, based on the output electric power from the fuel cells and the hot water storage state in the hot water tank. This arrangement ensures easy setting of the working conditions of the system. The control of the operations of the fuel cells may be attained by a variety of settings, for example, setting the output electric power from the fuel cells, the setting of a desired operation mode of the fuel cells selected among a plurality of predetermined operation modes, or the setting of the driving degree of the fuel cells. The hot water storage state in the hot water tank may be expressed by diversity of state quantities, for example, the amount of hot water kept in the hot water tank, the water level, the temperature of hot water, and the available amount of hot water supply.

In the first fuel cells power generation system of the invention, the display on the operation display module may include diverse pieces of information, for example, a working power used for a load, a power supply from another system power source connected in parallel with the system to the load, an operation mode of the fuel cells, in addition to the output electric power from the fuel cells and the hot water storage state in the hot water tank. The display on the display unit may be numerical values or stepwise-variable graphical expression. The display may include the occurrence of an abnormality in the system or a request for inspection of the system.

A second fuel cells power generation system of the present invention is a fuel cells power generation system, including:

fuel cells that receive a supply of a fuel and generate electric power;

an electric power conversion supply module that converts a direct current power from the fuel cells into a desired electric power and supplies the converted electric power to a power supply line from another system power source to a load; and

an operation display module having an operation unit that is manipulated to control operations of the fuel cells and a display unit that displays an output electric power from the fuel cells and a power supply from the another system power source to the load.

In the second fuel cells power generation system of the invention, the output electric power from the fuel cells and the power supply from another system power source to the load are displayed on the display unit of the operation display module. The user is accordingly informed of the output electric power from the fuel cells and the power supply from another system power source to the load. The user can thus manipulate the operation unit to control the operations of the fuel cells, based on the output electric power from the fuel cells and the power supply from the another system power source to the load. The operations of the fuel cells are controlled in the same manner as discussed above with regard to the first fuel cells power generation system of the invention.

In the second fuel cells power generation system of the invention, the display on the operation display module may include diverse pieces of information, for example, a working power used for a load, an operation mode of the fuel cells, in addition to the output electric power from the fuel cells and the power supply from another system power source to the load. The display on the display unit may be numerical values or stepwise-variable graphical expression. The display may include the occurrence of an abnormality in the system or a request for inspection of the system.

Another application of the invention is an operation display device having the operation display module used in either of the first fuel cells power generation system or the second fuel cells power generation system discussed above.

### BRIEF DESCRIPTION OF THE DRAWINGS

FIG. 1 schematically illustrates the construction of a fuel cells power generation system 20 in one embodiment of the present invention;

FIG. 2 shows the appearance of an operation display panel 70 in the embodiment;

FIG. 3 shows the appearance of the operation display panel 70 with a panel door 73 open;

FIG. 4 shows a modified example of the display unit;

FIG. 5 shows the appearance of an operation display panel 70B in a second embodiment of the invention;

FIG. 6 shows a modified example of the display unit;

FIG. 7 shows the appearance of an operation display panel 70C in one modified example;

FIG. 8 shows a modified example of the display unit;

FIG. 9 shows the appearance of an operation display panel 70D in one modified example;

FIG. 10 shows the appearance of an operation display panel 70E in one modified example;

### DESCRIPTION OF THE PREFERRED EMBODIMENTS

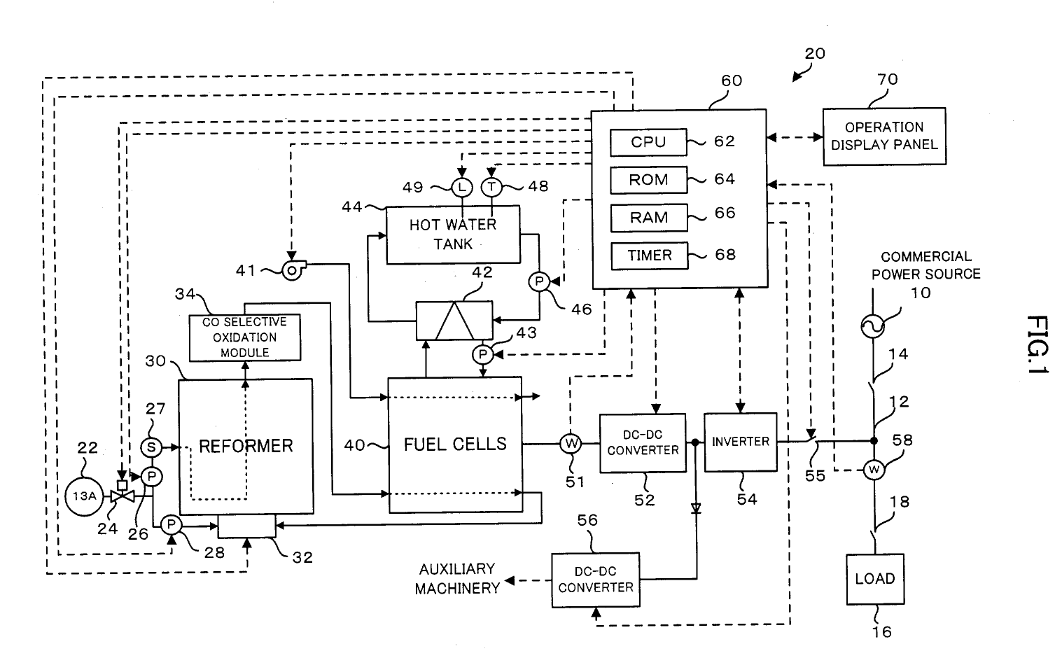

Some modes of carrying out the invention are discussed below as preferred embodiments. FIG. 1 schematically illustrates the construction of a fuel cells power generation system 20 in one embodiment of the present invention. The fuel cells power generation system 20 of the embodiment includes a reformer 30 that receives a supply of utility gas (for example, 13A) through a gas piping 22 and reforms the utility gas to a hydrogen-rich reformed gas, a CO selective oxidation module 34 that reduces the concentration of carbon monoxide contained in the reformed gas to produce a fuel gas, and a stack of fuel cells 40 that receives supplies of the fuel gas and the air and generates electric power through electrochemical reactions of the fuel gas with the air. The fuel cells power generation system 20 further includes a heat exchanger 42 that carries out heat exchange of cooling water circulated in the fuel cells 40 with low-temperature water stored in the hot water tank 44, a DC-DC converter 52 that regulates the voltage and the electric current of a direct current power output from the fuel cells 40 and thereby converts the output direct current power into a desired direct current power, and an inverter 54 that converts the converted direct current power into an alternating current power in the same phase as that of a commercial power source 10 and supplies the converted alternating current power via a circuit breaker 55 to a power line 12, through which electric power is supplied from the commercial power source 10 to a load 16 via a circuit breaker 14. The fuel cells power generation system 20 also has a DC-DC converter 56 that lowers part of the direct current power of the regulated voltage or electric current and utilizes the lowered direct current power as an auxiliary machinery power source, a load power meter 58 that measures a load power consumed by the load 16, an electronic control unit 60 that controls the whole system, and an operation display panel 70 that displays operating conditions of the system and is manipulated to control operations of the system.

The reformer 30 receives a supply of the utility gas fed from the gas piping 22 via a regulation valve 24, a booster pump 26, and a desulfurizer 27 for eliminating the sulfur content, as well as a supply of steam fed through a non-illustrated piping. The reformer 30 produces a hydrogen-rich reformed gas through a steam reforming reaction and a shift reaction of the utility gas and steam shown by Equations (1) and (2) given below. The reformer 30 has a combustion chamber 32, which supplies heat required for these reactions. The combustion chamber 32 receives a supply of the utility gas introduced from the gas piping 22 via the regulation valve 24 and a booster pump 28. The combustion chamber 32 also receives a supply of exhaust gas from an anode side of the fuel cells 40, and uses non-reacted hydrogen contained in an anode off gas as a fuel.

CH₄+H₂O→CO+3H₂ (1)

CO+H₂O→CO₂+H₂ (2)

The CO selective oxidation module 34 receives a supply of the air via a non-illustrated piping and selectively oxidizes carbon monoxide contained in the reformed gas with a carbon monoxide selective oxidation catalyst (for example, an alloy catalyst of platinum and ruthenium), which selectively oxidizes carbon monoxide in the presence of hydrogen. A resulting hydrogen-rich fuel gas output from the CO selective oxidation module 34 has an extremely low concentration of carbon monoxide (several ppm in this embodiment).

The fuel cells 40 are proton-exchange membrane fuel cells, which are obtained by laying multiple unit cells one upon another. Each unit cell has an electrolyte membrane, an anode electrode and a cathode electrode arranged across the electrolyte membrane, and a pair of separators that respectively feed the supplies of the fuel gas and the air to the anode electrode and the cathode electrode and work as partition walls between adjoining unit cells. The fuel cells 40 generate electric power through electrochemical reactions of hydrogen contained in the fuel gas supplied from the CO selective oxidation module 34 with oxygen contained in the air fed by a blower 41. The fuel cells 40 have a circulation flow path for cooling water. The temperature of the fuel cells 40 is kept in a preset range (in a range of 80 to 90° C. in this embodiment) by circulation of cooling water. The heat exchanger 42 is disposed in the circulation flow path of cooling water. The low-temperature water fed from the hot water tank 44 by means of a pump 46 is heated by heat exchange with the cooling water circulated in the fuel cells 40 and is returned to the hot water tank 44 to be stored therein.

An output terminal (not illustrated) of the fuel cells 40 is connected to the power line 12 between the commercial power source 10 and the load 16, via the DC-DC converter 52, the inverter 54, and the circuit breaker 55. The direct current power output from the fuel cells 40 is converted to an alternating current power in the same phase as that of the commercial power source 10 and is added to the alternating current power from the commercial power source 10. The total alternating current power is supplied to the load 16. The DC-DC converter 52 and the inverter 54 are constructed respectively as a general DC-DC converter circuit and a general inverter circuit, and are thus not specifically described here. The load 16 is connected to the power line 12 via a circuit breaker 18.

The DC-DC converter 56, which functions as a direct current power source and supplies a direct current power to auxiliary machinery including an actuator of the regulation valve 24, the booster pumps 26 and 28, the blower 41, and the pump 46, is connected to a power line branched off from the output of the DC-DC converter 52.

The electronic control unit 60 is constructed as a microprocessor including a CPU 62 as the main constituent. The electronic control unit 60 has a ROM 64 that stores processing programs, a RAM 66 that temporarily stores data, an input output port (not shown), and a communication port (not shown), in addition to the CPU 62. The electronic control unit 60 receives diverse measurement results and signals via the input port. The input data include an output electric power Pfc measured by a power meter 51 attached to the output terminal of the fuel cells 40, an output current and an output voltage measured by an ammeter and a voltmeter (not shown) set in the inverter 54, a load power Po measured by the load power meter 58, a temperature T of hot water kept in the hot water tank 44 and measured by a temperature sensor 48 attached to the hot water tank 44, a water level L of the hot water kept in the hot water tank 44 and measured by a water level sensor 49 attached to the hot water tank 44, temperatures measured by temperature sensors (not shown) attached to the reformer 30, the CO selective oxidation module 34, and the fuel cells 40, and operation signals output from the operation display panel 70. The electronic control unit. 60 outputs a diversity of signals via the output port, for example, driving signals to the actuator of the regulation valve 24, the booster pumps 26 and 28, the blower 41, a circulation pump 43, and the pump 46, an ignition signal to the combustion chamber 32, control signals to the DC-DC converter 52 and the DC-DC converter 56, switching control signals to the inverter 54, driving signals to the circuit breaker 55, and display signals to the operation display panel 70.

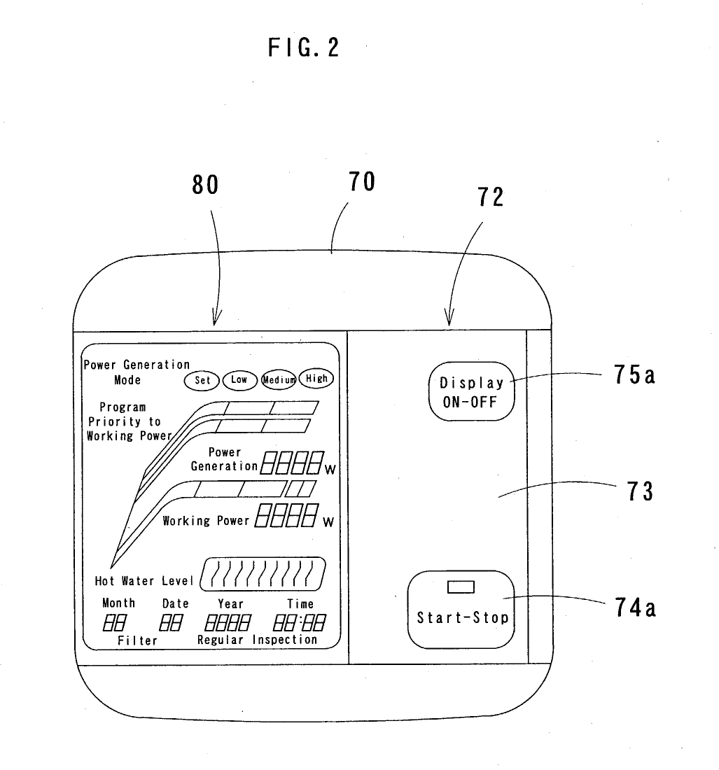

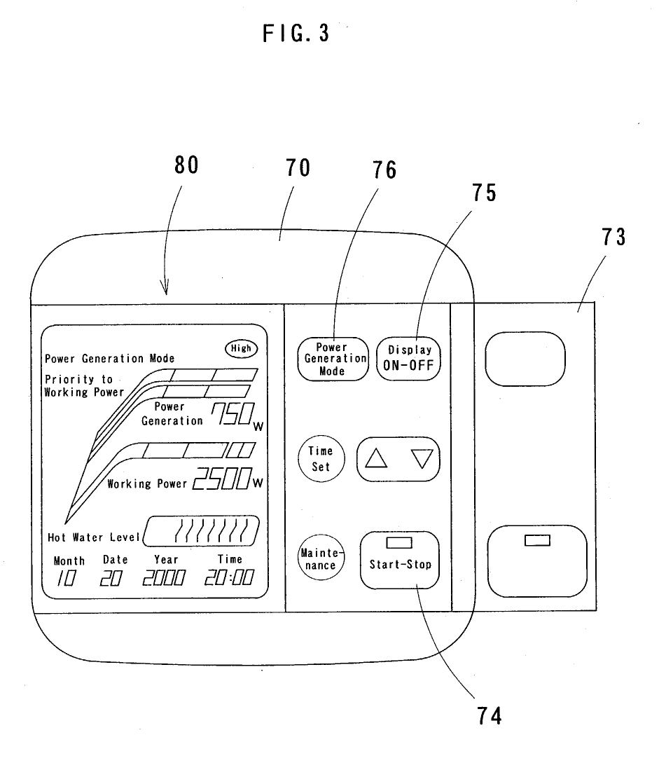

FIG. 2 shows the appearance of the operation display panel 70 included in the fuel cells power generation system 20 of the embodiment as one example. FIG. 3 shows the appearance of the operation display panel 70 with a panel door 73 open. As illustrated, the operation display panel 70 has an operation unit 72 that is manipulated to control operations of the system, and a display unit 80 that displays the driving conditions of the system. The operation display panel 70 may be located outdoors, like the fuel cells 40 and the hot water tank 44. Alternatively, only the operation display panel 70 may be located indoors.

As shown in FIG. 3, the operation unit 72 has a Start-Stop switch 74 to start and stop the operations of the system, a display ON-OFF switch 75 to switch over the ON-OFF state of display on the display unit 80, and a power generation mode switch 76 to switch over the power generation mode of the fuel cells 40, as membrane switches. The respective switch signals are input into the input port of the electronic control unit 60. The electronic control unit 60 controls the operations of the system, more specifically the operations of the fuel cells 40, in response to the respective input switch signals. The control of the operations is, however, not characteristic of the present invention and is thus not discussed here in detail. The panel door 73 has a Start-Stop switch operation window 74a and a display ON-OFF switch operation window 75a at specific positions corresponding to the Start-Stop switch 74 and the display ON-OFF switch 75. This arrangement enables the user to manipulate the Start-Stop switch 74 and the display ON-OFF switch 75 in the closed state of the panel door 73.

The display unit 80 is a liquid crystal display in this embodiment. As shown in FIGS. 2 and 3, the power generation mode of the fuel cells 40, the quantity of power generation by the fuel cells 40, the working power used for the load 16, the amount of hot water kept in the hot water tank 44, and the time are displayed as numerical values and stepwise-variable graphical expression representing variations in quantity. In this embodiment, the display of the power generation mode shows the current setting among three available modes, ‘High’, ‘Medium’, and ‘Low’. With regard to the quantity of power generation, the output power Pfc measured by the power meter 51 attached to the output terminal of the fuel cells 40 is displayed as a numerical value and as a stepwise graphic representation. With regard to the working power used for the load 16, the load power Po measured by the load power meter 58 attached to the power line 12 that supplies electric power from the commercial power source 10 to the load 16 is displayed as a numerical value and as a stepwise graphic representation. The amount of hot water is displayed as a stepwise graphic representation, based on the water level L measured by the water level sensor 49. The display unit 80 also has a display area on its bottom to show an abnormal state of the system, for example, clogging of a filter, conclusion of an operation of a preset time, and a request for regular inspection.

As discussed above, in the fuel cells power generation system 20 of the embodiment, the user is informed of the power generation mode of the fuel cells 40, the quantity of power generation by the fuel cells 40, the working power used for the load 16, the amount of hot water kept in the hot water tank 44, and the time, which are displayed on the display unit 80 of the operation display panel 70 as numerical values and stepwise-variable graphical expression representing variations in quantity. The user sets the power generation mode of the fuel cells 40, based on such information. This enables the user to adequately and readily control the operations of the system. The user is notified of the accurate information, since the quantity of power generation by the fuel cells 40, the working power used for the load 16, and the amount of hot water kept in the hot water tank 44 are displayed based on the measurements of the power meter 51, the load power meter 58, and the water level sensor 49.

In the fuel cells power generation system 20 of the embodiment, the display immediately informs the user of the occurrence of an abnormality in the system, for example, clogging of the filter. The display also notifies the user of a desired timing of regular inspection. This arrangement ensures stable operations of the fuel cells power generation system 20 under the favorable conditions.

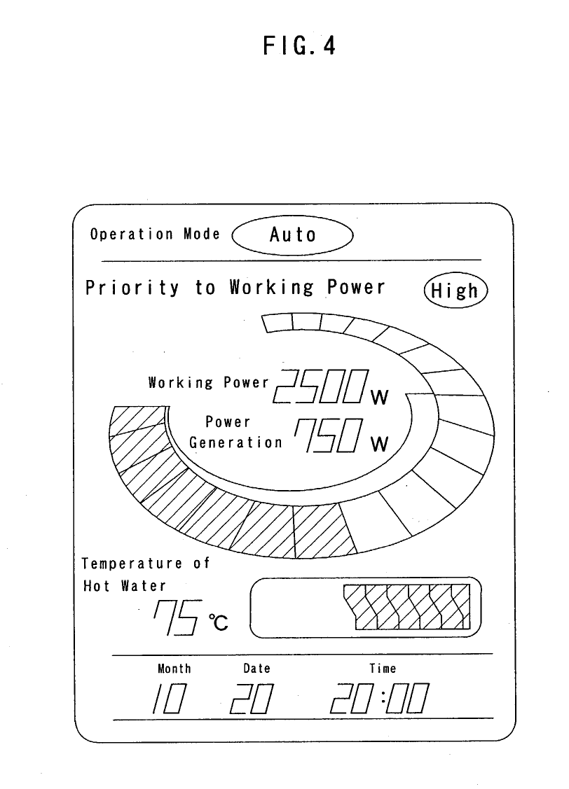

In the fuel cells power generation system 20 of the embodiment, the power generation mode of the fuel cells 40, the quantity of power generation by the fuel cells 40, the working power used for the load 16, the amount of hot water kept in the hot water tank 44, and the time are displayed on the display unit 80 of the operation display panel 70 as both the numerical values and the stepwise-variable graphical expression representing variations in quantity. The display is, however, not restricted to this embodiment, but the information can be expressed by a variety of displays. For example, the display on the display unit may not include any graphical expression but have only the numerical values. In another example, the display on the display unit may not include any numerical values but have only the graphical expression. In one modified structure, the display of the similar pieces of information on a display unit shown in FIG. 4 has a different graphical expression from that in the display on the display unit 80 of the operation display panel 70 shown in FIGS. 2 and 3. On the display unit of FIG. 4, one option ‘Auto’ is shown as an operation mode (power generation mode) in the setting of an auto mode that follows a variation in working power used for the load 16. The other option ‘Manual’ is shown in the setting of a manual mode that performs a constant operation regardless of the variation in working power used for the load 16.

In the fuel cells power generation system 20 of the embodiment, the quantity of power generation by the fuel cells 40, the working power used for the load 16, and the amount of hot water kept in the hot water tank 44 are displayed based on the measurements of the power meter 51, the load power meter 58, and the water level sensor 49. The display may, however, not be based on the measurements. For example, the quantity of power generation by the fuel cells 40 may be displayed according to the power generation mode of the fuel cells 40. The working power used for the load 16 may be displayed according to switch information of the load 16. The amount of hot water kept in the hot water tank 44 may be displayed according to the amount of hot water supply from the hot water tank 44 and the operating time of the fuel cells 40.

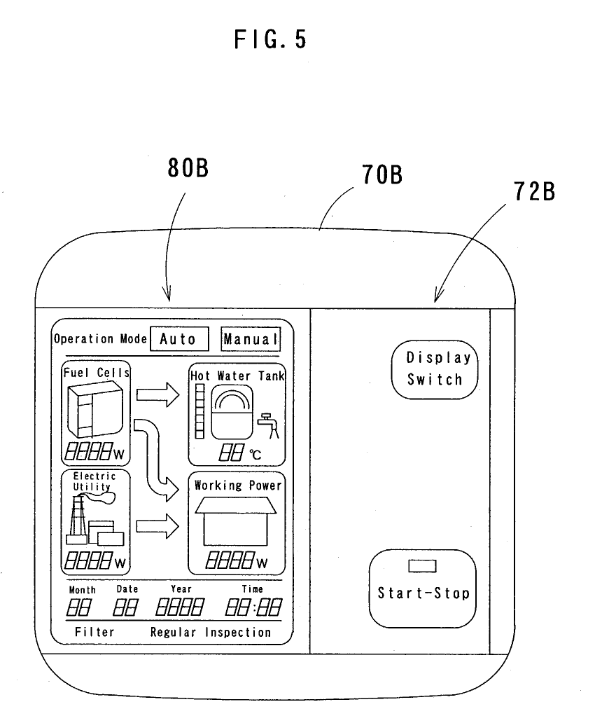

Another fuel cells power generation system 20B is discussed below as a second embodiment of the present invention. The fuel cells power generation system 20B of the embodiment has a similar configuration to that of the fuel cells power generation system 20 of the first embodiment, except that the operation display panel 70 shown in FIG. 2 is replaced by an operation display panel 70B shown in FIG. 5. The fuel cells power generation system 20B of the second embodiment is thus not specifically described nor illustrated, except the operation display panel 70B. Like the operation display panel 70 included in the fuel cells power generation system 20 of the first embodiment, the operation display panel 70B included in the fuel cells power generation system 20B of the second embodiment has an operation unit 72 that is manipulated to control the operations of the system and a display unit 80B that displays the driving conditions of the system, as shown in FIG. 5. The operation unit 72B is identical with the operation unit 72 of the operation display panel 70 of the first embodiment and is not discussed here.

The display unit 80B of the operation display panel 70B of the second embodiment is a liquid crystal display. As shown in FIG. 5, the display on the display unit 80B includes the operation mode of the fuel cells 40, the quantity of power generation by the fuel cells 40, the power supply from the commercial power source 10 (electric utility), the working power used for the load 16, the amount and the temperature of hot water kept in the hot water tank 44, and the time as numerical values and stepwise-variable graphical expression representing variations in quantity. In the structure of the second embodiment, the quantity of power generation by the fuel cells 40, the power supply from the commercial power source 10 (electric utility), the working power used for the load 16, and the amount and the temperature of hot water kept in the hot water tank 44 are displayed according to the results of measurements by means of the power meter 51, the load power meter 58, the temperature sensor 48, and the water level sensor 49. On the display unit 80B of the second embodiment, variations in quantity of heat applied to the hot water tank 44, in quantity of power generation by the fuel cells 40, and in power supply from the commercial power source 10 (electric utility) are expressed by varying the thickness of corresponding arrows in a stepwise manner. On the display unit 80B of the second embodiment, one option ‘Auto’ is shown while an auto mode that follows a variation in working power used for the load 16 is set for the operation mode. The other option ‘Manual’ is shown while a manual mode that performs a constant operation regardless of the variation in working power used for the load 16 is set for the operation mode. The display unit 80B of the operation display panel 70B of the second embodiment also has a display area to show an abnormal state of the system, for example, clogging of a filter and a request for regular inspection.

As discussed above, in the fuel cells power generation system 20B of the second embodiment, the user is informed of the operation mode of the fuel cells 40, the quantity of power generation by the fuel cells 40, the power supply from the commercial power source 10 (electric utility), the working power used for the load 16, the amount of hot water kept in the hot water tank 44, the temperature of hot water kept in the hot water tank 44, and the time, which are displayed on the display unit 80B of the operation display panel 70B as numerical values and stepwise-variable graphical expression representing variations in quantity. The user sets the operation mode of the fuel cells 40, based on such information. This enables the user to adequately and readily control the operations of the system. The user is notified of the accurate information, since the quantity of power generation by the fuel cells 40, the power supply from the commercial power source 10, the working power used for the load 16, and the amount and the temperature of hot water kept in the hot water tank 44 are displayed based on the measurements of the power meter 51, the load power meter 58, the water level sensor 49, and the temperature sensor 48. In the fuel cells power generation system 20B of the second embodiment, the display informs the user of the occurrence of an abnormality in the system, for example, clogging of the filter and a desired timing of regular inspection. This arrangement ensures stable operations of the fuel cells power generation system 20B under the favorable conditions.

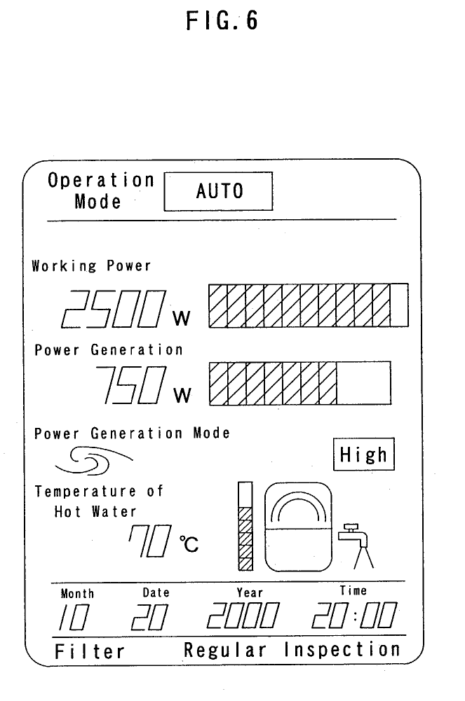

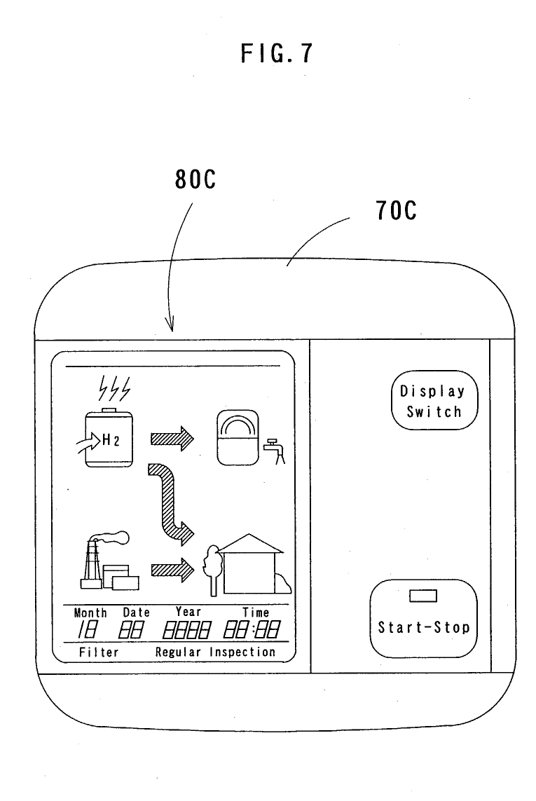

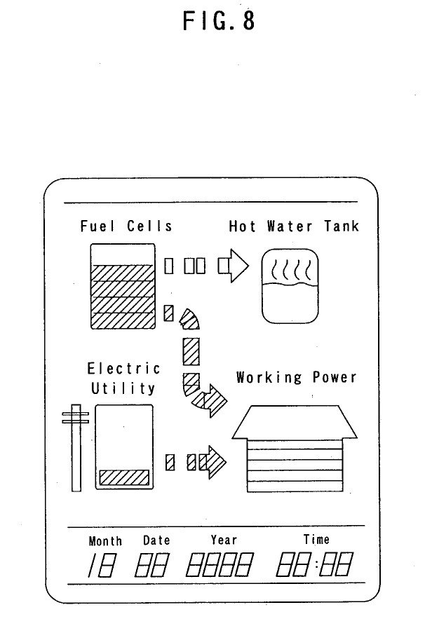

In the fuel cells power generation system 20B of the second embodiment, the operation mode of the fuel cells 40, the quantity of power generation by the fuel cells 40, the power supply from the commercial power source 10 (electric utility), the working power used for the load 16, the amount of hot water kept in the hot water tank 44, the temperature of hot water kept in the hot water tank 44, and the time are displayed on the display unit 80B of the operation display panel 70B as both the numerical values and the stepwise-variable graphical expression representing variations in quantity. The display is, however, not restricted to this embodiment, but the information can be expressed by a variety of displays. For example, the display of the similar pieces of information on a display unit shown in FIG. 6 has a different graphical expression, that is, bar graphs, from that in the display on the display unit 80B of the operation display panel 70B of the second embodiment shown in FIG. 5. The display on the display unit may not include any graphical expression but have only the numerical values. In another example, the display on the display unit may not include any numerical values but have only the graphical expression, like a display unit 80C of an operation display panel 70C shown in FIG. 7 and a display unit of its modification shown in FIG. 8.

The graphical expression on the display unit 80 of the operation display panel 70 of the first embodiment or on the display unit 80B of the operation display panel 70B of the second embodiment may be a graphic representation that varies the length of graphs in a stepwise manner to represent variations in quantity as shown in FIGS. 2, 4, and 6. Another example is an arrow representation that varies the thickness of arrows in a stepwise manner to represent variations in quantity and indicates the directions by arrows as shown in FIGS. 5 and 7. Still another example is another arrow representation that varies the density of arrows in a stepwise manner to represent variations in quantity and indicates the directions by the arrows and the density variation lines as shown in FIG. 8. Other available examples, which are not illustrated, include a character representation that varies the number of characters in a stepwise manner to represent variations in quantity, and another character representation that varies the filled percent or density of a character in a stepwise manner to represent variations in quantity.

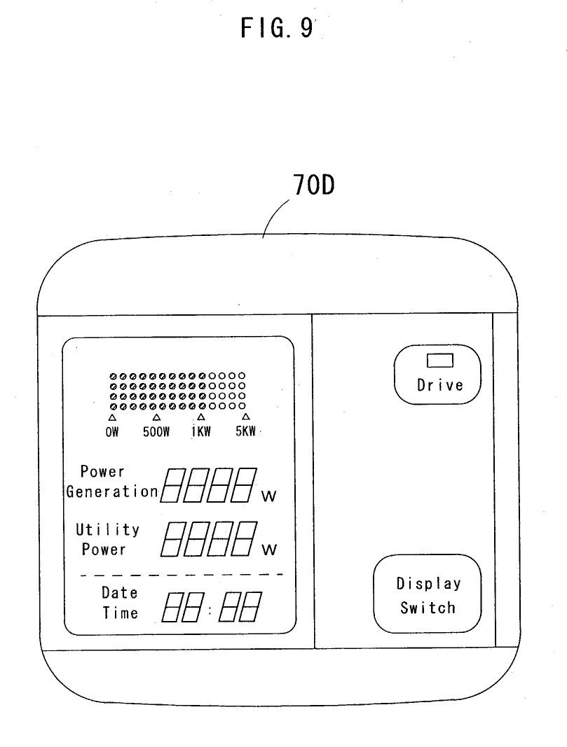

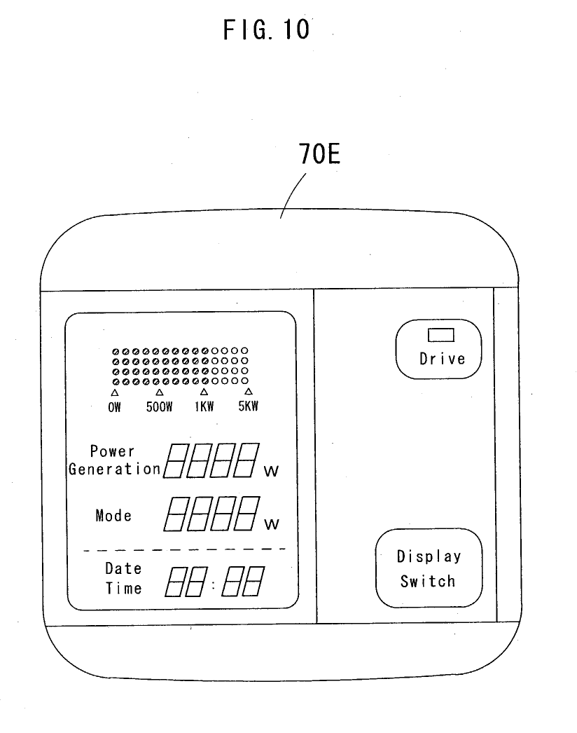

In the first embodiment, the display on the display unit 80 of the operation display panel 70 includes the power generation mode of the fuel cells 40, the quantity of power generation by the fuel cells 40, the working power used for the load 16, the amount of hot water kept in the hot water tank 44, the time, the occurrence of an abnormality in the system, and a request for regular inspection. In the second embodiment, the display on the display unit 80B of the operation display panel 70B includes the operation mode of the fuel cells 40, the quantity of power generation by the fuel cells 40, the power supply from the commercial power source 10 (electric utility), the working power used for the load 16, the amount of hot water kept in the hot water tank 44, the temperature of hot water kept in the hot water tank 44, the time, the occurrence of an abnormality in the system, and a request for regular inspection. The pieces of information displayed on the display unit of the operation display panel are, however, not restricted to these embodiments. The display on an operation display panel 70D of one modified example shown in FIG. 9 includes only the quantity of power generation by the fuel cells 40, the power supply (utility power) from the commercial power source 10, and the working power used for the load 16. The display on an operation display panel 70E of another modified example shown in FIG. 10 includes only the quantity of power generation by the fuel cells 40, the operation mode of the fuel cells 40, and the working power used for the load 16. In another example, the display may include only the quantity of power generation by the fuel cells 40 and the amount and the temperature of hot water kept in the hot water tank 44. In still another example, the display may include only the quantity of power generation by the fuel cells 40 and the power supply from the commercial power source 10. In another example, the display may include only the quantity of power generation by the fuel cells 40 and the working power used for the load 16. The display may include the quantity of power generation by the fuel cells 40 and any of diverse combinations of other pieces of information. The display many not include the occurrence of an abnormality in the system or a request for regular inspection.

In the fuel cells power generation system 20 of the first embodiment and the fuel cells power generation system 20B of the second embodiment, the amount of hot water kept in the hot water tank 44 is varied. The hot water tank may be a closed type, where only the temperature of hot water is varied while the water level is always kept at full. This structure does not require the water level sensor 49.

In the fuel cells power generation system 20 of the first embodiment and the fuel cells power generation system 20B of the second embodiment, proton-exchange membrane fuel cells are applied for the fuel cells 40. The fuel cells 40 are, however, not restricted to the proton-exchange membrane fuel cells but any other suitable fuel cells.

In the fuel cells power generation system 20 of the first embodiment and the fuel cells power generation system 20B of the second embodiment, the reformer 30 receives the supply of the utility gas (13A) and produces the hydrogen-rich fuel gas. The reformer 30 may alternatively receive a supply of another utility gas (12A) or propane gas filled with a gas tank and produce the fuel gas.

In the fuel cells power generation system 20 of the first embodiment and the fuel cells power generation system 20B of the second embodiment, the utility gas is converted to the hydrogen-rich fuel gas by means of the reformer 30 and the CO selective oxidation module 34 and is supplied to the fuel cells 40. A hydrogen-rich fuel gas or pure hydrogen may alternatively be supplied from a hydrogen tank to the fuel cells 40.

The fuel cells power generation system 20 of the first embodiment and the fuel cells power generation system 20B of the second embodiment have the hot water tank 44 that heats water with heat of the fuel cells 40 and stores hot water. The hot water tank 44 may be excluded from the fuel cells power generation system.

The above embodiments are to be considered in all aspects as illustrative and not restrictive. There may be many modifications, change, and alterations without departing from the scope or sprit of the main characteristics of the present invention. All changes within the meaning and range of equivalency of the claims are therefore intended to be embraced therein.

What is claimed is:

1. A fuel cells power generation system, comprising:
fuel cells that receive a supply of a fuel and generate electric power;
a hot water tank that stores hot water heated with at least heat from said fuel cells; and
an operation display module having an operation unit that is manipulated to control operations of said fuel cells and a display unit that displays an output electric power from said fuel cells and a hot water storage state in said hot water tank.

2. A fuel cells power generation system in accordance with claim 1, said fuel cells power generation system further comprising:
an output electric power detection module that measures the output electric power from said fuel cells; and
a hot water storage state detection module that detects the hot water storage state in said hot water tank,
wherein said operation display module receives inputs of the observed output electric power from said fuel cells and the detected hot water storage state in said hot water tank and displays the inputs on said display unit.

3. A fuel cells power generation system in accordance with claim 1, said fuel cells power generation system further comprising:
an electric power conversion supply module that converts the output electric power from said fuel cells into a desired electric power and supplies the converted electric power to a power supply line from another system power source to a load,
wherein said operation display module displays a working power used for the load on said display unit.

4. A fuel cells power generation system in accordance with claim 3, said fuel cells power generation system further comprising:
a working power detection module that measures the working power used for the load,
wherein said operation display module receives an input of the observed working power and displays the input on said display unit.

5. A fuel cells power generation system in accordance with claim 3, wherein said operation display module displays a power supply from said another system power source to the load, instead of the working power, on said display unit.

6. A fuel cells power generation system in accordance with claim 3, wherein said operation display module displays a power supply from said another system power source to the load, in addition to the working power, on said display unit.

7. A fuel cells power generation system in accordance with claim 1, wherein said display unit of said operation display module has a display of numerical values.

8. A fuel cells power generation system in accordance with claim 1, wherein said display unit of said operation display module has a display of a stepwise-variable graphical expression representing variations.

9. A fuel cells power generation system in accordance with claim 1, wherein an operation mode of said fuel cells is selected among a plurality of predetermined operation modes and is set on said operation unit of said operation display module, and
said display unit of said operation display module displays the setting of the selected operation mode.

10. A fuel cells power generation system in accordance with claim 1, wherein said operation display module displays occurrence of an abnormality in said system.

11. A fuel cells power generation system in accordance with claim 1, wherein said operation display module displays a request for an inspection of said system.

12. A fuel cells power generation system, comprising:
fuel cells that receive a supply of a fuel and generate electric power;
an electric power conversion supply module that converts a direct current power from said fuel cells into a desired electric power and supplies the converted electric power to a power supply line from another system power source to a load; and
an operation display module having an operation unit that is manipulated to control operations of said fuel cells and a display unit that displays an output electric power from said fuel cells and a power supply from said another system power source to the load.

13. A fuel cells power generation system in accordance with claim 12, said fuel cells power generation system further comprising:
an output electric power detection module that measures the output electric power from said fuel cells; and
a power supply detection module that detects the power supply from said another system power source to the load,
wherein said operation display module receives inputs of the observed output electric power from said fuel cells and the detected power supply from said another system power source to the load and displays the inputs on said display unit.

14. A fuel cells power generation system in accordance with claim 13, wherein said operation display module displays a working power used for the load, instead of the power supply, on said display unit.

15. A fuel cells power generation system in accordance with claim 13, wherein said operation display module displays a working power used for the load, in addition to the power supply, on said display unit.

16. A fuel cells power generation system in accordance with claim 12, wherein said display unit of said operation display module has a display of numerical values.

17. A fuel cells power generation system in accordance with claim 12, wherein said display unit of said operation display module has a display of a stepwise-variable graphical expression representing variations.

18. A fuel cells power generation system in accordance with claim 12, wherein an operation mode of said fuel cells is selected among a plurality of predetermined operation modes and is set on said operation unit of said operation display module, and
said display unit of said operation display module displays the setting of the selected operation mode.

19. A fuel cells power generation system in accordance with claim 12, wherein said operation display module displays occurrence of an abnormality in said system.

20. A fuel cells power generation system in accordance with claim 12, wherein said operation display module displays a request for an inspection of said system.

21. An operation display device that is used for a fuel cells power generation system, which comprises fuel cells receiving a supply of a fuel and generating electric power and a hot water tank storing hot water heated with at least heat from said fuel cells,
said operation display device comprising:
an operation unit that is manipulated to control operations of said fuel cells; and
a display unit that displays an output electric power from said fuel cells and a hot water storage state in said hot water tank.

22. An operation display device that is used for a fuel cells power generation system, which comprises fuel cells receiving a supply of a fuel and generating electric power and an electric power conversion supply module that converts a direct current power from said fuel cells into a desired electric power and supplies the converted electric power to a power supply line from another system power source to a load,
said operation display device comprising:
an operation unit that is manipulated to control operations of said fuel cells; and
a display unit that displays an output electric power from said fuel cells and a power supply from said another system power source to the load.

23. An operation display device in accordance with claim 22, wherein said display unit displays a working power used for the load, in place of the power supply.

24. An operation display device in accordance with claim 22, wherein said display unit displays a working power used for the load, in addition to the power supply.
